(19) United States
(12) Patent Application Publication
(10) Pub. No.: US 2026/0343203 A1
(43) Pub. Date: Oct. 29, 2026

(54) DISCOVERY OF PASSIVE RADIO DEVICES

(71) Applicant: Nokia Technologies Oy, Espoo (FI)

(72) Inventors: Oana-Elena BARBU, Aalborg (DK); Benny VEJLGAARD, Aalborg (DK); Johannes HARREBEK, Aalborg (DK); Simon SVENDSEN, Aalborg (DK)

(21) Appl. No.: 19/107,443

(22) PCT Filed: Sep. 2, 2022
(86) PCT No.: PCT/EP2022/074410

§ 371 Date: Feb. 27, 2025

(51) Int. Cl. H04W 8/00; H04W 24/08

(52) U.S. Cl. CPC H04W 8/005; H04W 24/08

(57) ABSTRACT

Disclosed is a method comprising receiving association information that comprises information regarding a plurality of passive radio devices and to which respective radio devices they are assigned, wherein the radio devices are configured to transmit an activation signal to the passive radio devices assigned to them, determining categories for the passive radio devices comprised in the plurality of passive radio devices based, at least partly, on response signals received from at least some of the passive radio devices comprised in the plurality of the passive radio devices, determining functionality regarding activating to be performed by the radio devices based on the category determined for passive radio devices assigned to them, and transmitting to the radio devices requests, wherein the requests indicate the functionality regarding activating to be performed by the radio devices.

### FIELD

The following exemplary embodiments relate to wireless communication and connections with passive radio devices.

### BACKGROUND

Wireless communication networks, such as cellular communication networks evolve, and may be utilized for various purposes including Internet of Things (IoT). The connections used for IoT are predicted to increase significantly. As there will be a great amount of devices interconnected, it is beneficial to improve production efficiency and increase comforts of life by for example further reducing size, cost, and power consumption for passive radio device, which may act as IoT devices.

### BRIEF DESCRIPTION

The scope of protection sought for various embodiments of the invention is set out by the independent claims. The exemplary embodiments and features, if any, described in this specification that do not fall under the scope of the independent claims are to be interpreted as examples useful for understanding various embodiments of the invention.

According to a first aspect there is provided an apparatus comprising means for receiving association information that comprises information regarding a plurality of passive radio devices and to which respective radio devices they are assigned, wherein the radio devices are configured to transmit an activation signal to the passive radio devices assigned to them, determining categories for the passive radio devices comprised in the plurality of passive radio devices based, at least partly, on response signals received from at least some of the passive radio devices comprised in the plurality of the passive radio devices, determining functionality regarding activating to be performed by the radio devices based on the category determined for passive radio devices assigned to them, and transmitting to the radio devices requests, wherein the requests indicate the functionality regarding activating to be performed by the radio devices.

In some example embodiments according to the first aspect, the means comprises at least one processor, and at least one memory, including a computer program code, wherein the at least one memory and the computer program code are configured, with the at least one processor, to cause the performance of the apparatus.

According to a second aspect there is provided an apparatus comprising at least one processor, and at least one memory including a computer program code, wherein the at least one memory and the computer program code are configured, with the at least one processor, to cause the apparatus to: receive association information that comprises information regarding a plurality of passive radio devices and to which respective radio devices they are assigned, wherein the radio devices are configured to transmit an activation signal to the passive radio devices assigned to them, determine categories for the passive radio devices comprised in the plurality of passive radio devices based, at least partly, on response signals received from at least some of the passive radio devices comprised in the plurality of the passive radio devices, determine functionality regarding activating to be performed by the radio devices based on the category determined for passive radio devices assigned to them, and transmit to the radio devices requests, wherein the requests indicate the functionality regarding activating to be performed by the radio devices.

According to a third aspect there is provided a method comprising: receiving association information that comprises information regarding a plurality of passive radio devices and to which respective radio devices they are assigned, wherein the radio devices are configured to transmit an activation signal to the passive radio devices assigned to them, determining categories for the passive radio devices comprised in the plurality of passive radio devices based, at least partly, on response signals received from at least some of the passive radio devices comprised in the plurality of the passive radio devices, determining functionality regarding activating to be performed by the radio devices based on the category determined for passive radio devices assigned to them, and transmitting to the radio devices requests, wherein the requests indicate the functionality regarding activating to be performed by the radio devices.

In some example embodiments according to the third aspect, the method is a computer-implemented method.

According to a fourth aspect there is provided a computer program comprising instructions for causing an apparatus to perform at least the following: receive association information that comprises information regarding a plurality of passive radio devices and to which respective radio devices they are assigned, wherein the radio devices are configured to transmit an activation signal to the passive radio devices assigned to them, determine categories for the passive radio devices comprised in the plurality of passive radio devices based, at least partly, on response signals received from at least some of the passive radio devices comprised in the plurality of the passive radio devices, determine functionality regarding activating to be performed by the radio devices based on the category determined for passive radio devices assigned to them, and transmit to the radio devices requests, wherein the requests indicate the functionality regarding activating to be performed by the radio devices.

According to a fifth aspect there is provided a computer program comprising instructions stored thereon for performing at least the following: receiving association information that comprises information regarding a plurality of passive radio devices and to which respective radio devices they are assigned, wherein the radio devices are configured to transmit an activation signal to the passive radio devices assigned to them, determining categories for the passive radio devices comprised in the plurality of passive radio devices based, at least partly, on response signals received from at least some of the passive radio devices comprised in the plurality of the passive radio devices, determining functionality regarding activating to be performed by the radio devices based on the category determined for passive radio devices assigned to them, and transmitting to the radio devices requests, wherein the requests indicate the functionality regarding activating to be performed by the radio devices.

According to a sixth aspect there is provided a non-transitory computer readable medium comprising program instructions for causing an apparatus to perform at least the following: receive association information that comprises information regarding a plurality of passive radio devices and to which respective radio devices they are assigned, wherein the radio devices are configured to transmit an activation signal to the passive radio devices assigned to them, determine categories for the passive radio devices comprised in the plurality of passive radio devices based, at least partly, on response signals received from at least some of the passive radio devices comprised in the plurality of the passive radio devices, determine functionality regarding activating to be performed by the radio devices based on the category determined for passive radio devices assigned to them, and transmit to the radio devices requests, wherein the requests indicate the functionality regarding activating to be performed by the radio devices.

According to a seventh aspect there is provided a non-transitory computer readable medium comprising program instructions stored thereon for performing at least the following: receiving association information that comprises information regarding a plurality of passive radio devices and to which respective radio devices they are assigned, wherein the radio devices are configured to transmit an activation signal to the passive radio devices assigned to them, determining categories for the passive radio devices comprised in the plurality of passive radio devices based, at least partly, on response signals received from at least some of the passive radio devices comprised in the plurality of the passive radio devices, determining functionality regarding activating to be performed by the radio devices based on the category determined for passive radio devices assigned to them, and transmitting to the radio devices requests, wherein the requests indicate the functionality regarding activating to be performed by the radio devices.

According to an eighth aspect there is provided a computer readable medium comprising program instructions stored thereon for performing at least the following: receiving association information that comprises information regarding a plurality of passive radio devices and to which respective radio devices they are assigned, wherein the radio devices are configured to transmit an activation signal to the passive radio devices assigned to them, determining categories for the passive radio devices comprised in the plurality of passive radio devices based, at least partly, on response signals received from at least some of the passive radio devices comprised in the plurality of the passive radio devices, determining functionality regarding activating to be performed by the radio devices based on the category determined for passive radio devices assigned to them, and transmitting to the radio devices requests, wherein the requests indicate the functionality regarding activating to be performed by the radio devices.

According to a ninth aspect there is provided a system comprising at least a first radio device, a second radio device and a third radio device, wherein the system comprises means for: receiving, by the first radio device, association information that comprises information regarding a plurality of passive radio devices and to which of the second or the third radio device they are assigned, wherein the second and the third radio devices are configured to transmit an activation signal to the passive radio devices assigned to them, determining, by the first radio device, categories for the passive radio devices comprised in the plurality of passive radio devices based, at least partly, on response signals received from at least some of the passive radio devices comprised in the plurality of the passive radio devices, determining, by the first radio device, functionality regarding activating to be performed by the second radio devices based on the categories determined for passive radio devices assigned to it, and determining, by the first radio device, functionality regarding activating to be performed by the third radio devices based on the categories determined for passive radio devices assigned to it, and transmitting, by the first radio device, to the second radio devices a request, wherein the request indicates the functionality regarding activating to be performed by the second radio device, and transmitting, by the first radio device, to the third radio device another request, wherein the other request indicates the functionality regarding activating to be performed by the third radio device.

According to a tenth aspect there is provided a system comprising at least a first radio device, a second radio device and a third radio device, wherein the system is configured to: receive, by the first radio device, association information that comprises information regarding a plurality of passive radio devices and to which of the second or the third radio device they are assigned, wherein the second and the third radio devices are configured to transmit an activation signal to the passive radio devices assigned to them, determine, by the first radio device, categories for the passive radio devices comprised in the plurality of passive radio devices based, at least partly, on response signals received from at least some of the passive radio devices comprised in the plurality of the passive radio devices, determine, by the first radio device, functionality regarding activating to be performed by the second radio devices based on the categories determined for passive radio devices assigned to it, and determine, by the first radio device, functionality regarding activating to be performed by the third radio devices based on the categories determined for passive radio devices assigned to it, and transmit, by the first radio device, to the second radio devices a request, wherein the request indicates the functionality regarding activating to be performed by the second radio device, and transmit, by the first radio device, to the third radio device another request, wherein the other request indicates the functionality regarding activating to be performed by the third radio device.

According to an eleventh aspect there is provided an apparatus comprising means for: receiving, from another radio device, a request that indicates functionality regarding activating to be performed by the apparatus with respect to a passive radio device, determining, based on the request, if the functionality regarding activating comprises transmitting an activation signal to the passive radio device, wherein the activation signal causes the passive radio device to transmit a response signal, and if yes, determining characteristics regarding transmitting the activation signal, and performing the functionality regarding activating with respect to the passive radio device.

In some example embodiments according to the eleventh aspect, the means comprises at least one processor, and at least one memory, including a computer program code, wherein the at least one memory and the computer program code are configured, with the at least one processor, to cause the performance of the apparatus.

According to a twelfth aspect there is provided an apparatus comprising at least one processor, and at least one memory including a computer program code, wherein the at least one memory and the computer program code are configured, with the at least one processor, to cause the apparatus to: receive, from another radio device, a request that indicates functionality regarding activating to be performed by the apparatus with respect to a passive radio device, determine, based on the request, if the functionality regarding activating comprises transmitting an activation signal to the passive radio device, wherein the activation signal causes the passive radio device to transmit a response signal, and if yes, determine characteristics regarding transmitting the activation signal and perform the functionality regarding activating with respect to the passive radio device.

According to a thirteenth aspect there is provided a method comprising: receiving, from another radio device, a request that indicates functionality regarding activating to be performed by the apparatus with respect to a passive radio device, determining, based on the request, if the functionality regarding activating comprises transmitting an activation signal to the passive radio device, wherein the activation signal causes the passive radio device to transmit a response signal, and if yes, determining characteristics regarding transmitting the activation signal, and performing the functionality regarding activating with respect to the passive radio device.

In some example embodiments according to the thirteenth aspect, the method is a computer-implemented method.

According to a fourteenth aspect there is provided a computer program comprising instructions for causing an apparatus to perform at least the following: receive, from another radio device, a request that indicates functionality regarding activating to be performed by the apparatus with respect to a passive radio device, determine, based on the request, if the functionality regarding activating comprises transmitting an activation signal to the passive radio device, wherein the activation signal causes the passive radio device to transmit a response signal, and if yes, determine characteristics regarding transmitting the activation signal and perform the functionality regarding activating with respect to the passive radio device.

According to a fifteenth aspect there is provided a computer program comprising instructions stored thereon for performing at least the following: receiving, from another radio device, a request that indicates functionality regarding activating to be performed by the apparatus with respect to a passive radio device, determining, based on the request, if the functionality regarding activating comprises transmitting an activation signal to the passive radio device, wherein the activation signal causes the passive radio device to transmit a response signal, and if yes, determining characteristics regarding transmitting the activation signal, and performing the functionality regarding activating with respect to the passive radio device.

According to a sixteenth aspect there is provided a non-transitory computer readable medium comprising program instructions for causing an apparatus to perform at least the following: receive, from another radio device, a request that indicates functionality regarding activating to be performed by the apparatus with respect to a passive radio device, determine, based on the request, if the functionality regarding activating comprises transmitting an activation signal to the passive radio device, wherein the activation signal causes the passive radio device to transmit a response signal, and if yes, determine characteristics regarding transmitting the activation signal and perform the functionality regarding activating with respect to the passive radio device.

According to a seventeenth aspect there is provided a non-transitory computer readable medium comprising program instructions stored thereon for performing at least the following: receiving, from another radio device, a request that indicates functionality regarding activating to be performed by the apparatus with respect to a passive radio device, determining, based on the request, if the functionality regarding activating comprises transmitting an activation signal to the passive radio device, wherein the activation signal causes the passive radio device to transmit a response signal, and if yes, determining characteristics regarding transmitting the activation signal, and performing the functionality regarding activating with respect to the passive radio device.

### LIST OF DRAWINGS

In the following, the invention will be described in greater detail with reference to the embodiments and the accompanying drawings, in which

FIG. 1 illustrates an exemplary embodiment of a radio access network.

FIG. 2 illustrates an example embodiment of activating and discovering a passive radio device.

FIG. 3 illustrates a signalling chart according to an example embodiment.

FIG. 4 and FIG. 5 illustrate example embodiments of an apparatus.

### Description of Embodiments

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. The above-described embodiments of the circuitry may also be considered as embodiments that provide means for carrying out the embodiments of the methods or processes described in this document.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via any suitable means. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments described herein may be implemented in a communication system, such as in at least one of the following: Global System for Mobile Communications (GSM) or any other second generation cellular communication system, Universal Mobile Telecommunication System (UMTS, 3G) based on basic wideband-code division multiple access (W-CDMA), high-speed packet access (HSPA), Long Term Evolution (LTE), LTE-Advanced, a system based on IEEE 802.11 specifications, a system based on IEEE 802.15 specifications, and/or a fifth generation (5G) mobile or cellular communication system. The embodiments are not, however, restricted to the system given as an example but a person skilled in the art may apply the solution to other communication systems provided with necessary properties.

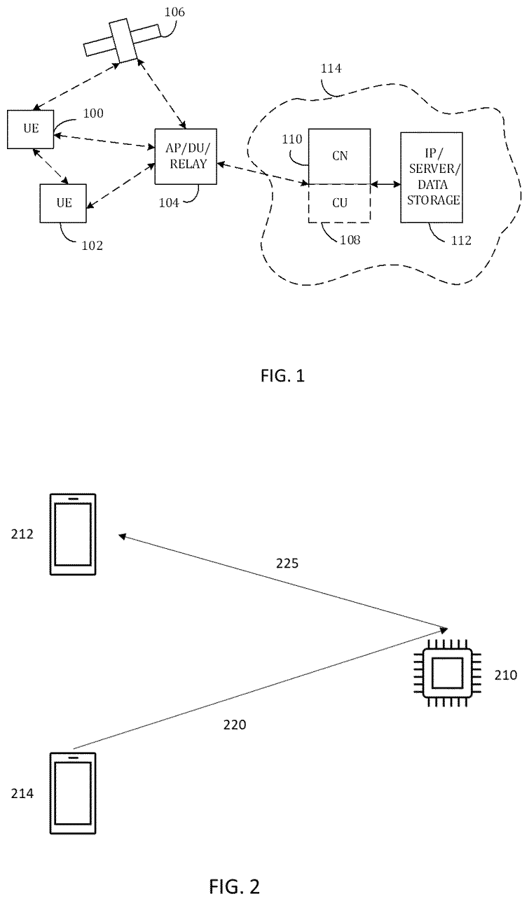

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may comprise also other functions and structures than those shown in FIG. 1. The example of FIG. 1 shows a part of an exemplifying radio access network.

FIG. 1 shows terminal devices 100 and 102 configured to be in a wireless connection on one or more communication channels in a cell with an access node (such as (e/g) NodeB) 104 providing the cell. The access node 104 may also be referred to as a node. The wireless link from a terminal device to a (e/g)NodeB is called uplink or reverse link and the wireless link from the (e/g)NodeB to the terminal device is called downlink or forward link. It should be appreciated that (e/g)NodeBs or their functionalities may be implemented by using any node, host, server or access point etc. entity suitable for such a usage. It is to be noted that although one cell is discussed in this exemplary embodiment, for the sake of simplicity of explanation, multiple cells may be provided by one access node in some exemplary embodiments.

A communication system may comprise more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The (e/g)NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side may be a serving gateway (S-GW, routing and forwarding user data packets), packet data network gateway (P-GW), for providing connectivity of terminal devices (UEs) to external packet data networks, or mobile management entity (MME), etc.

The terminal device (also called UE, user equipment, user terminal, user device, etc.) illustrates one type of an apparatus to which resources on the air interface are allocated and assigned, and thus any feature described herein with a terminal device may be implemented with a corresponding apparatus, such as a relay node. An example of such a relay node is a layer 3 relay (self-backhauling relay) towards the base station. Another example of such a relay node is a layer 2 relay. Such a relay node may contain a terminal device part and a Distributed Unit (DU) part. A CU (centralized unit) may coordinate the DU operation via F1AP-interface for example.

The terminal device may refer to a portable computing device that includes wireless mobile communication devices operating with or without a subscriber identification module (SIM), or an embedded SIM, eSIM, including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be an exclusive or a nearly exclusive uplink only device, of which an example is a camera or video camera loading images or video clips to a network. A terminal device may also be a device having capability to operate in Internet of Things (IoT) network which is a scenario in which objects are provided with the ability to transfer data over a network without requiring human-to-human or human-to-computer interaction. The terminal device may also utilise cloud. In some applications, a terminal device may comprise a small portable device with radio parts (such as a watch, earphones or eyeglasses) and the computation is carried out in the cloud. The terminal device (or in some embodiments a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications such as (massive) machine-type communications (mMTC), including vehicular safety, different sensors and real-time control. 5G is expected to have multiple radio interfaces, namely below 6GHz, cmWave and mmWave, and also being integratable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6GHz-cmWave, below 6GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G may require bringing the content close to the radio which may lead to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, and/or utilise services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of labour between core network operations and base station operations may differ from that of the LTE or even be non-existent. Some other technology that may be used includes for example Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling or service availability in areas that do not have terrestrial coverage. Satellite communication may utilise geostationary earth orbit (GEO) satellite systems, but also low earth orbit (LEO) satellite systems, for example, mega-constellations. A satellite 106 comprised in a constellation may carry a gNB, or at least part of the gNB, that create on-ground cells. Alternatively, a satellite 106 may be used to relay signals of one or more cells to the Earth. The on-ground cells may be created through an on-ground relay node 104 or by a gNB located on-ground or in a satellite or part of the gNB may be on a satellite, the DU for example, and part of the gNB may be on the ground, the CU for example. Additionally, or alternatively, high-altitude platform station, HAPS, systems may be utilized.

It is to be noted that the depicted system is an example of a part of a radio access system and the system may comprise a plurality of (e/g)NodeBs, the terminal device may have an access to a plurality of radio cells and the system may comprise also other apparatuses, such as physical layer relay nodes or other network elements, etc. At least one of the (e/g)NodeBs may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. In some exemplary embodiments, in multilayer networks, one access node provides one kind of a cell or cells, and thus a plurality of (e/g) NodeBs are required to provide such a network structure.

For fulfilling the need for improving the deployment and performance of communication systems, the concept of “plug-and-play” (e/g)NodeBs has been introduced. A network which is able to use “plug-and-play” (e/g) NodeBs, may include, in addition to Home (e/g)NodeBs (H(e/g)nodeBs), a home node B gateway, or HNB-GW (not shown in FIG. 1). A HNB Gateway (HNB-GW), which may be installed within an operator's network may aggregate traffic from a large number of HNBs back to a core network.

Internet of Things (IOT) is envisaged to grow rapidly. IoT, which may utilize 5G connectivity, may thus comprise passive radios, which may be understood to be devices that are passive radio devices, such as tags and/or sensors. The passive radio devices, may also be understood as IoT devices, when those are part of an IoT use cases. These passive radio devices require power to be able to transmit and/or receive data. The passive radio devices may consume for example tens or hundreds of milliwatts power during transceiving. Thus, it is beneficial to consider how to optimize power consumption as well as obtaining of power, such that it is possible to achieve the internet of everything. Therefore, it is desirable to have passive radio devices with ten or even a hundred times lower cost and power consumption. Also, as for IoT applications, 3GPP has specified NB-IoT/eMTC and NR reduced capability (RedCap) to satisfy the requirements on low cost and low power devices for wide area IoT communication.

One aspect to consider in relation to target use cases involving passive radio devices is the capability of cooperating with energy harvesting considering limited device size. Cellular devices may consume tens or even hundreds of milliwatts power for transceiving processing. Taking an NB-IoT module for example, the current consumption for receive processing may be, for example, about 60 mA with supply voltage higher than 3.1V, while 70 mA for transmitting processing at 0 dBm transmit power. The output power provided by an energy harvester may be mostly below 1 milliwatt, considering the small size of a few square centimeters for practical devices. Since the available power may be far less than the consumed power, it may be impractical to power cellular devices directly by energy harvesting in some use cases.

With more and more things expected to be interconnected for improving production efficiency and increasing comforts of life, it may demand further reduction of size, cost, and power consumption for passive radio devices. Further, some applications utilizing IoT may require passive radio devices that are batteryless. This may be for example because replacement of battery for some passive radio devices may be impractical as that would mean tremendous consumption of materials and manpower. Thus, energy harvesting may be utilized to power passive radio devices for self-sustainable communications for example in applications with a huge number of devices such as ID tags and sensors.

One option for batteryless passive devices, such as tags, is to utilize radio frequency identification (RFID). In some examples, an RFID tag may have a power consumption as low as 1 microwatt. Techniques enabling such low power consumption include envelope detection for downlink data reception, and backscatter communication for uplink data transmission. RFID may utilize envelope detection for downlink data reception and backscatter communication for uplink data transmission. In an example embodiment there may be a passive communication between a reader device and a tag. The reader device comprises a unit configured to transmit and receive signals. The unit has, in this example embodiment, a transmitter for broadband transmissions and the transmitter is followed by a power amplifier and an antenna that then transmits a carrier wave. The tag then has an antenna that receives the carrier wave. The tag then modifies one or more characteristics of the carrier wave. The characteristics may comprise for example amplitude, phase and/or center frequency. The tag may comprise various units with which the modification can be achieved. In this example embodiment, the tag comprises at least the following units: an RF harvester for harvesting electromagnetic energy from an incoming RF signal, a detection unit for detecting the incoming RF signal, a clock for generating a clock signal, and a logic unit for controlling the operation of the tag. The signal, after the modification, is then reflected, by the tag, as an uplink reflected signal. The uplink reflected signal is then received by the antenna of the reader after which the signal is amplified using a low noise amplifier after which the receiver receives the reflected signal. As such, data transmission may be obtained without generating a carrier wave by the tag, which reduces required energy demands as well as costs.

It is to be noted that some research show that a few or tens of microwatts power consumption can be supported for passive tags based on or with small modifications to the air interfaces. Some of such studies are targeting at long range communication. Among them, a long range (LoRa) tag implemented with commercial off-the-shelf components can send its sensing data to the receiver of 381 meters away for example.

In applications related to passive devices, there may be devices, that may be understood as radio devices, that have different roles. An activation radio device, which may also be referred to as an activator, may be understood as a device that sends an NR activation signal intended for one or more passive radios such as tags or sensors. The activator may be a terminal device, an access node such as a gNB, a transmit receive point (TRP), etc. A passive radio device, which may also be referred to as a passive radio device, that may harvest energy from the NR activation signal and generate a response signal, which may be called as a backscatter signal, either on the same or different frequency in the NR spectrum as the activation signal. Thus, the activation signal may provide a trigger for the passive radio device to transmit a response signal, and optionally, the passive radio device may also harvest energy from the activation signal. The response signal may also encode information that is specific to the passive radio device, such as its identity (ID) A reading radio device, which may also be referred to as a reader, may be understood as a radio device that listens for the response signals from one or more tags and attempts to detect the IDs of the active tags. The reader may be a terminal device, an access node such as a gNB, a TRP, etc.

A passive radio device, such as a tag or a sensor, may operate in at least two modes. One mode is an energy harvesting mode in which the passive radio device collects energy from wireless signals that are transmitted towards the passive radio device on a given spectra. Another mode is a data transfer mode in which the passive radio device may generate a unique signal. The unique signal then carries data specific to the passive radio device such as its ID or data collected by the passive radio device. These two modes may be implemented in a half- or full duplex manner, in other words, sequentially or simultaneously. To support interactions between the passive radio device and 5G network infrastructure, the passive radio device is to obtain sufficient energy to become discoverable in case the passive radio device is not equipped with a power source.

To support and integrate passive radio devices, such as tags, in a network infrastructure, one initial task for the network is to find the passive radio devices as there may be no active (i.e. with a power source) elements on the passive radio devices, and thus no means for the passive radio devices to make themself visible or heard. For example, the problem may be challenging in mmWave frequencies as the active entities, such as access nodes and terminal devices, may receive and transmit directionally.

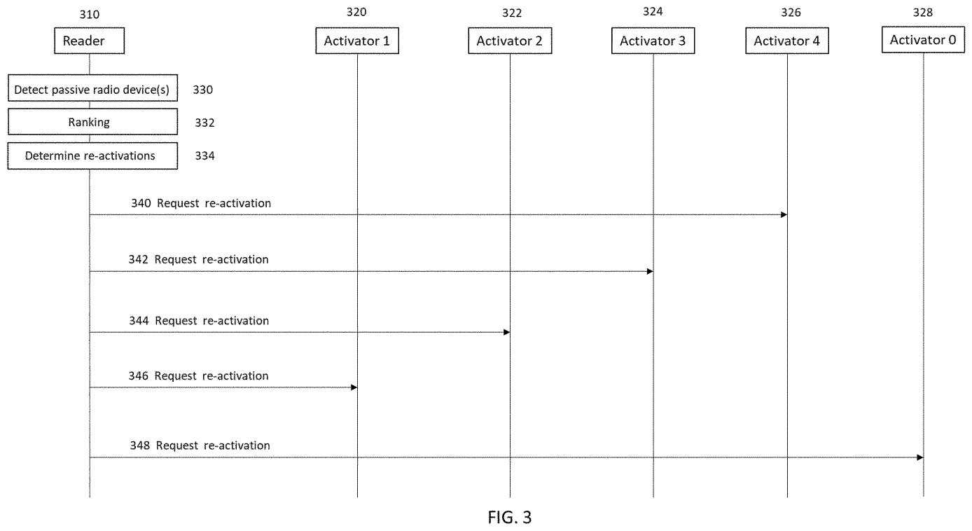

An example embodiment of activating and discovering a passive radio device is illustrated in FIG. 2. In this example embodiment there are radio devices of which at least one is a passive radio device, at least one radio device is having the role of an activator and at least one radio device is having the role of a reader. In this example embodiment, the passive radio device is a tag 210, the radio device acting as a reader is a terminal device 212 and the radio device acting as an activator is a terminal device 214. However, it is to be noted that in some alternative example embodiments, the activator 214 may be another radio device, for example an access node such as an eNB or a gNB, and/or the reader 212 may be another radio device as well, for example an access node such as an eNB or a gNB. The activator 214 transmits an activation signal 220 to the tag 210 and the tag 210 then responds by transmitting a signal indicating its presence which is then received by the reader 212. It is to be noted that in some other example embodiments there may be a plurality of tags to which the terminal device 214 transmits the activation signal and the reader 212 may receive a response from a plurality of tags.

Discovering and/or ranging to a passive radio device may be a challenging task due to the inherent nature of the passive radio. For example, the passive radio may not have a power source, as described above, and it may be mobile and also its capability to hear other radio devices may be limited to its own proximity, such as within a 5-10 m radius. Additionally, its mobility and operation, for example how much data it has collected, may be transparent to the network. Because of the above limitations, the paging operations applicable to terminal devices may not be usable and thus having an activator in proximity to the passive tag may be beneficial.

As is mentioned above, the passive radio device may be discovered by other radio devices if the passive radio device receives an activation signal and then transmits a response signal indicating its presence such that another radio device is capable of receiving the response signal. Yet, this procedure may in some cases involve interference. An example of such interference is passive radio device-to-passive radio device interference, which occurs when signals from multiple tags collide at the reader which is unable to distinguish between them. This may be the situation, when multiple passive radio devices are activated and those respond simultaneously, and the passive radio devices closer to the reader drown the signals of those passive radio devices placed further away. Another example of an occurrence of interference is an activator-to-passive radio device interference, which occurs when the activation signal drowns the signal from the passive radio device as received by a reader. This may be the situation, when the activation signal, which is much stronger than a signal from the passive radio device, drowns the response signal transmitted by the passive radio device, preventing the reader from detecting the passive radio device. In both examples, the interference is observed by the reader.

Thus, it is beneficial to reduce the interference observed by a reader. One approach that may be utilized is to coordinate functionalities regarding activating of activators, when there are multiple activators. For example, the reader may rank different passive radio devices, when there is a plurality of passive radio devices, and trigger the subsequent functionalities of the activators (e.g., turn off, retransmission pattern, etc.) in relation to the ranking of the passive radio devices.

In an example embodiment, the reader may rank a plurality of passive radio devices, from which it has received a response signal indicating the presence of the respective passive radio devices, by the quality of the discovery results, which are based on the quality of the received response signals. Thus, the passive radio devices may be ranked based on the quality of their respective response signals received by the reader. Based on the ranking, the reader may then prioritize and co-schedule retransmissions of activation signals for one or more of the passive radio devices, by the one or more activators. In this example embodiment, the reader has been informed about an association between an activator ID and a list of passive radio devices that an activator targets. In other words, the reader has been informed regarding which passive radio devices have been assigned to which activator.

The message that the reader may then transmit in order to prioritize and co-schedule retransmissions of activation signals, may be a request that comprises a flag regarding a passive radio device, a delay and optionally also results, such as received power, of the first attempt to discover the passive radio device. A flag regarding a passive radio device may be for example a high flag, that indicates that the reactivation of the passive radio device should be treated with high priority by the activator, or a low flag, that indicates that the reactivation may be handled after all high priority passive radio devices have been reactivated. A delay may indicate when, after the reception of the message transmitted by the reader, another activation signal, which may be referred to as a retransmission of an activation signal, should be transmitted to the passive radio device by its respective activator. The message may be transmitted using various means depending on whether the activator is comprised in an access node or in a terminal device and whether the reader is comprised in an access node or in a terminal device. For example, the message may be transmitted using an information element in a physical sidelink shared channel (SL PSSCH IE), using downlink or uplink small data transmission (DL/UL SDT), or a payload in physical down- or uplink shared channel (PD/USCH). It is to be noted that the flag, the delay and/or transmission power to be used for the other activation signal, may be understood to be characteristics of an activation signal. Characteristics of an activation signal may additionally, or alternatively, comprise also other indications regarding when and the activation signal is to be transmitted.

Based on the ranking, the reader may then terminate functionality regarding activating of one or more activators. The termination may be achieved by transmitting an indication, such as a short message indicator, carrying a list of IDs of passive radio devices and an associated termination flag associated to the group e.g., terminate=TRUE for {tag1, . . . tagX}, and the message may be transmitted over SL or U/DL data channels.

FIG. 3 illustrates a signalling chart in accordance with an example embodiment in which a reader 310 may rank passive radio devices and then modify functionality regarding activation of a plurality of activators, which in this example embodiment are the activators 320, 322, 324, 326 and 328. In this example embodiment the reader 310 may be any suitable radio device such as a terminal device or an access node. In this example embodiment, a coordinating entity, such as a location management function (LMF) comprised in a network such as 5G network, or a terminal device, may select activator-reader pairs for a plurality of passive radio devices such as tags. The coordinating entity in this example embodiment informs the reader 310 about the IDs of the activators 320, 322, 324, 326 and 328 and one or more passive radio devices assigned to each of the activators. The coordinator provides the reader 310 the right to coordinate functionalities regarding activating of the activators 320, 322, 324, 326 and 328 and may also request the reader 310 to collect a target key performance indicators (KPIs) per passive radio devices, and test at least one of the KPIs against a threshold value that may be referred to as T1. KPIs may be regarding one or more signal measurements obtained from the response signals, such as time of arrival, received power, etc.

In this example embodiment, the activators 320, 322, 324, 326 and 328 transmit activation signals to one or more passive radio devices assigned to them, which are referred to as targeted passive radio devices. The targeted passive radio devices then receive their respective activation signals and respond with a response signal that is the specific response signal associated with each of the passive radio device, and which may be referred to as a response signal from the passive radio signal or backscatter. The reader 310 then receives one or more response signals from the passive radio devices and thus detects a subset of passive radio devices, wherein the subset is less than or equal to the amount of target passive radio devices. Thus, as illustrates in block 330, the reader 310 detects at least one passive radio device comprised in the targeted passive radio devices.

Next, the reader 310 performs ranking of the targeted passive radio devices, in other words, the passive radio devices it has been assigned to detect, as illustrated in block 332. The ranking may be performed such that the passive radio devices are assigned into categories. There may be various categories for the ranking, such as high-quality passive radio devices and low-quality passive radio devices. It is to be noted that also other categories may be utilized. The high-quality passive radio devices may comprise passive radio devices the detection of which was determined to be successful and a target KPI was detected to be higher than the threshold T1. The target KPI may comprise one or more of time of arrival, received power, etc. It is also to be noted that the T1 may be pre-determined by the co-ordinator, or it may be pre-determined autonomously by the reader 310. Low quality passive radio devices may be radio devices whose detection was successful and the KPI is below the threshold T1. Additionally, there may be a third category for failed detection that comprises passive radio devices that are among the target passive radio devices but were not detected. It is to be noted that although three different categories are mentioned herein, in some other example embodiments there may be a different number of categories. For example, if there are N categories, there may then be N different functionalities regarding activating, which activators are to perform with regard to their assigned passive radio devices. It is also to be noted though that there may be more than one KPI that is tested against respective target values. Based the results of testing the one or more KPIs against their respective target values, the passive radio devices may then be assigned to different categories.

Then in block 334, the reader 310 determines subsequent functionalities regarding activating for the activators 320, 322, 324, 326 and 328 based on the ranking, that is, based on category the one or more passive radio devices assigned to the of the activators 320, 322, 324, 326 and 328. The activators of the passive radio devices assigned to the high-quality category, are determined to be such that they are requested to stop sending activation signal towards passive radio devices in this category. The activators of the passive radio devices assigned to the low-quality category, are determined to be such that they are requested to retransmit an activation signal towards passive radio devices in this category. The activators of the passive radio devices assigned to the failed category, are determined to be such that they are requested retransmit an activation signal towards passive radio devices in this category and the retransmission is to be with highest power and highest priority.

In this example embodiment, there are two passive radio devices, ID3 and ID4, with respective activators 322 and 320 assigned to the second category, which is the low-quality category. The reader 310 determined in this example embodiment that the activators 322 and 320 are to retransmit the activation signals to the respective passive radio devices. The reader 310 may also attach a delay indicator for each activator 322 and 320 that indicates timing regarding when the activators should start sending the activation signal. This may be beneficial in order to avoid a situation in which the activators simultaneously re-transmit the activation signals to their assigned passive radio devices that are in the same category and thus minimizing thus both activator-to-passive radio device and passive radio device-to-passive radio device interference. For example, the reader 310 may determine that activator 326 is to retransmit its activation signal at dt4 seconds after it has received this request and the activator 324 is to retransmit its activation signal at dt3≠dt4 seconds after it has received this request. It may also be determined that activation signals are to be re-transmitted with highest power and highest priority, indicating that the tags where not detected. Optionally, also information regarding the KPIs of the passive radio devices assigned to the activator 324 may the transmitted.

Thus, the reader 310 transmits the request 340 to the activator 326. The request 340 is a request for retransmitting an activation signal to the passive radio device ID4 assigned to the activator 326. The request may further indicate the delay dt4, the KPIs associated with the passive radio device ID4 assigned to the activator 326 and an indication that the retransmission is to be transmitted with the highest priority and highest power.

The reader 310 also transmits the request 342 to the activator 324. The request 342 is a request for retransmitting an activation signal to the passive radio device ID3 assigned to the activator 324. The request may further indicate the delay dt3, the KPIs associated with the passive radio device ID3 assigned to the activator 326 and an indication that the retransmission is to be transmitted with the highest priority and highest power.

In this example embodiment, there are two passive radio devices, ID1 and ID2, with respective activators 326 and 324 assigned to the third category, which is the failed category. The reader 310 determined in this example embodiment that the activators 326 and 324 are to retransmit the activation signals to the respective passive radio devices assigned to them. The reader 310 may also attach a delay indicator for each activator 322 and 320 that indicates timing regarding when the activators should start sending the activation signal. For example, the reader 310 may determine that activator 322 is to retransmit its activation signal at dt2 seconds after it has received this request and the activator 320 is to retransmit its activation signal at dt1≠dt2 seconds after it has received this request. It may also be determined that activation signals are to be re-transmitted with lowest priority. Optionally, also information regarding the KPIs of the passive radio devices assigned to the activators 322 and 320 may then be transmitted. It is to be noted that in this example embodiment, dt3<<min{dt1, dt2} and dt4≠dt3 and dt4<<min{dt1, dt2}.

Thus, the reader 310 transmits the request 344 to the activator 322. The request 342 is a request for retransmitting an activation signal to the passive radio device ID2 assigned to the activator 322. The request may further indicate the delay dt2, the KPIs associated with the passive radio device ID2 assigned to the activator 322 and an indication that the retransmission is to be transmitted with the lowest priority.

The reader 310 also transmits the request 346 to the activator 320. The request 346 is a request for retransmitting an activation signal to the passive radio device ID1 assigned to the activator 320. The request may further indicate the delay dt1, the KPIs associated with the passive radio device ID1 assigned to the activator 320 and an indication that the retransmission is to be transmitted with the lowest priority.

In this example embodiment, there is one passive radio device with ID0 and with respective activator 328 assigned to the first category, which is the high-quality category. As the reader 310 determined that the passive radio device ID0 was successfully detected, the reader 310 transmits the request 348 to the activator 328 to which the passive radio device ID0 is assigned. The request 348 comprises a request to deactivate sending of activation signals to the passive radio device ID0. The deactivation thus helps to ensure that no activation signals of passive radio devices in the high-quality category interfere with the reception of response signals from other passive radio devices, thereby helping to reduce the activator-to-passive radio device interference. The request 348 comprises at least the identity of the passive radio device in this category and optionally also the measured KPI for the passive radio device. This may be useful for example if the activator 328 requires the KPI for further processing regarding the passive radio device.

The example embodiments described above may have advantages such as optimizing transmission of an activator, minimizing passive radio device-to-passive radio device interference and/or minimizing activator-to-passive radio device interference.

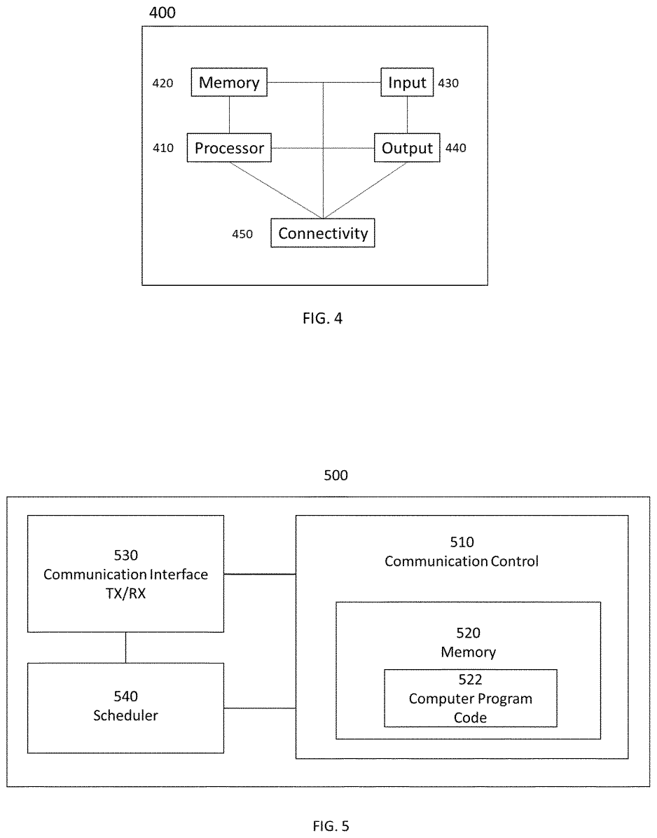

FIG. 4 illustrates an apparatus 400, which may be an apparatus such as, or comprised in, a terminal device, according to an example embodiment, and that may embody the activator or the reader as described above. The apparatus 400 comprises a processor 410. The processor 410 interprets computer program instructions and processes data. The processor 410 may comprise one or more programmable processors. The processor 410 may comprise programmable hardware with embedded firmware and may, alternatively or additionally, comprise one or more application specific integrated circuits, ASICs.

The processor 410 is coupled to a memory 420. The processor is configured to read and write data to and from the memory 420. The memory 420 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example RAM, DRAM or SDRAM. Non-volatile memory may be for example ROM, PROM, EEPROM, flash memory, optical storage or magnetic storage. In general, memories may be referred to as non-transitory computer readable media. The memory 420 stores computer readable instructions that are execute by the processor 410. For example, non-volatile memory stores the computer readable instructions and the processor 410 executes the instructions using volatile memory for temporary storage of data and/or instructions.

The computer readable instructions may have been pre-stored to the memory 420 or, alternatively or additionally, they may be received, by the apparatus, via electromagnetic carrier signal and/or may be copied from a physical entity such as computer program product. Execution of the computer readable instructions causes the apparatus 400 to perform functionality described above.

In the context of this document, a “memory” or “computer-readable media” may be any non-transitory media or means that can contain, store, communicate, propagate or transport the instructions for use by or in connection with an instruction execution system, apparatus, or device, such as a computer.

The apparatus 400 further comprises, or is connected to, an input unit 430. The input unit 430 comprises one or more interfaces for receiving a user input. The one or more interfaces may comprise for example one or more motion and/or orientation sensors, one or more cameras, one or more accelerometers, one or more microphones, one or more buttons and one or more touch detection units. Further, the input unit 430 may comprise an interface to which external devices may connect to.

The apparatus 400 also comprises an output unit 440. The output unit comprises or is connected to one or more displays capable of rendering visual content such as a light emitting diode, LED, display, a liquid crystal display, LCD and a liquid crystal on silicon, LCOS, display. The output unit 440 further comprises one or more audio outputs. The one or more audio outputs may be for example loudspeakers or a set of headphones.

The apparatus 400 may further comprise a connectivity unit 450. The connectivity unit 450 enables wired and/or wireless connectivity to external networks. The connectivity unit 450 may comprise one or more antennas and one or more receivers that may be integrated to the apparatus 400 or the apparatus 400 may be connected to. The connectivity unit 450 may comprise an integrated circuit or a set of integrated circuits that provide the wireless communication capability for the apparatus 400. Alternatively, the wireless connectivity may be a hardwired application specific integrated circuit, ASIC.

It is to be noted that the apparatus 400 may further comprise various component not illustrated in the FIG. 4. The various components may be hardware component and/or software components.

The apparatus 500 of FIG. 5 illustrates an example embodiment of an apparatus that may be an access node or be comprised in an access node, and that may embody the activator or the reader as described above. The apparatus may be, for example, a circuitry or a chipset applicable to an access node to realize the described embodiments. The apparatus 500 may be an electronic device comprising one or more electronic circuitries. The apparatus 500 may comprise a communication control circuitry 510 such as at least one processor, and at least one memory 520 including a computer program code (software) 522 wherein the at least one memory and the computer program code (software) 522 are configured, with the at least one processor, to cause the apparatus 500 to carry out any one of the example embodiments of the access node described above.

The memory 520 may be implemented using any suitable data storage technology, such as semiconductor-based memory devices, flash memory, magnetic memory devices and systems, optical memory devices and systems, fixed memory and removable memory. The memory may comprise a configuration database for storing configuration data. For example, the configuration database may store current neighbour cell list, and, in some example embodiments, structures of the frames used in the detected neighbour cells.

The apparatus 500 may further comprise a communication interface 530 comprising hardware and/or software for realizing communication connectivity according to one or more communication protocols. The communication interface 530 may provide the apparatus with radio communication capabilities to communicate in the cellular communication system. The communication interface may, for example, provide a radio interface to terminal devices. The apparatus 500 may further comprise another interface towards a core network such as the network coordinator apparatus and/or to the access nodes of the cellular communication system. The apparatus 500 may further comprise a scheduler 540 that is configured to allocate resources.

Even though the invention has been described above with reference to example embodiments according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

### LIST OF ABBREVIATIONS

AD—assistance data
ASIC—application-specific integrated system
CA—carrier aggregation
CB-TT—crossbeam cross-barrier tap tracking
CL—carrier list
CN—core network
CP—carrier phase
CPS—cyber-physical system
CU—centralized unit
DL—downlink
DL-AoD—downlink angle of departure
DL-TDOA—downlink time-difference of arrival
DRAM—dynamic random-access memory
DSP—digital signal processing
DSPD—digital signal processing device
DU—distributed unit
E-CID—enhanced cell-ID
EEPROM—electronically erasable programmable read-only memory
eSIM—embedded subscriber identification module
FPGA—field programmable gate array
FR1—frequency range 1
FR2—frequency range 2
GEO—geostationary earth orbit
gNB—g nodeB
GPU—graphics processing unit
GSM—global system for mobile communications
HAPS—high-altitude platform station
HNB—home node B
HSPA—high-speed packet access
ICT—interconnected
ID—identity
IE—information element
IoT—Internet of things
KPI—Key performance indicator
LED—light emitting diode
LEO—low earth orbit
LCD—liquid crystal display
LCOS—liquid crystal on silicon
LMF—location management function
LoRa—long range
LOS—line of sight
LPP—LTE positioning protocol
LTE—long term evolution
MEC—multi-access edge computing
MIMO—multiple input-multiple output
MME—mobile management entity
mMTC—massive machine-type communication
Multi-RTT—multi-cell round trip time
NB-IoT—narrowband Internet of things
NFV—network function virtualization
NGC—next generation core
NLOS—non-line of sight
NR—new radio
PDA—personal digital assistant
PDSCH—physical downlink shared channel
P-GW—packet data network gateway
PLD—programmable logic devices
PROM—programmable read-only memory
PRS—positioning reference signal
PSSCH—physical sidelink shared channel
PUSCH—physical uplink shared channel
RAM—random access memory
RAN—radio access network
RAT—radio access technology
RF—radio frequency
RI—radio interface
ROM—read-only memory
Rx—receive
SDN—software defined networking
SDRAM—synchronous dynamic random access memory
SDT—small data transmission
SGW—serving gateway
SIM—subscriber identification module
SL—sidelink
TRP—Transmission and reception point.
Tx—transmit
UE—user equipment
UL—uplink
UL—AoA-uplink angle of arrival
UL—TDOA-uplink time-difference of arrival
UMTS—universal mobile telecommunication system
W-CDMA—wideband-code division multiple access

1. An apparatus comprising at least one processor, and at least one memory including a computer program code, wherein the at least one memory and the computer program code are configured, with the at least one processor, to cause the apparatus to:
receive association information that comprises information regarding a plurality of passive radio devices and to which respective radio devices they are assigned, wherein the radio devices are configured to transmit an activation signal to the passive radio devices assigned to them;
determine categories for the passive radio devices comprised in the plurality of passive radio devices based, at least partly, on response signals received from at least some of the passive radio devices comprised in the plurality of the passive radio devices;
determine functionality regarding activating to be performed by the radio devices based on the category determined for passive radio devices assigned to them; and
transmit to the radio devices requests, wherein the requests indicate the functionality regarding activating to be performed by the radio devices.

2. The apparatus according to claim 1, wherein the apparatus is further caused to test one or more key performance indicators against their respective threshold values, wherein the key performance indicators are regarding one or more signal measurements obtained from the received response signals.

3. The apparatus according to claim 2, wherein the apparatus is further caused to determine categories for the passive radio devices from which the response signals were received based on the testing of the one or more key performance indicators against their respective threshold values.

4. The apparatus according to claim 1, wherein the apparatus is further caused to:
receive a first response signal from a first passive radio device comprised in the plurality of passive radio devices;
determine that at least one key performance indicator obtained from the received first response signal has a value greater than a first threshold value and, based on that determination, categorize the first passive radio device into a first category; and
determine that the functionality regarding activating, for a first radio device, to which the first passive radio device is assigned, comprises de-activating retransmission of a first activation signal to the first passive radio device.

5. The apparatus according to claim wherein the apparatus is further caused to:
receive a second response signal from a second passive radio device comprised in the plurality of passive radio devices;
determine that at least one key performance indicator obtained from the received second response signal has a value less than the first threshold value and, based on that determination, categorize the second passive radio device into a second category; and
determine that the functionality regarding activating, for a second radio device, to which the second passive radio device is assigned, comprises retransmission of a second activation signal to the second passive radio device.

6. The apparatus according to claim 5, wherein the functionality regarding activating for a second radio device, to which the second passive radio device is assigned, comprises a first delay for the retransmission of the second activation signal.

7. The apparatus according to claim 1, wherein the apparatus is further caused to:
determine that a third response signal from a third passive radio device comprised in the plurality of passive radio devices has not been received;
categorize the second passive radio device into a third category; and
determine that the functionality regarding activating for a third radio device, to which the third passive radio device is assigned, comprises retransmission of a third activation signal to the second passive radio device.

8. The apparatus according to claim 7, wherein the functionality regarding activating for a second radio device, to which the second passive radio device is assigned, comprises a second delay for the retransmission of the second activation signal.

9. The apparatus according to claim 6, wherein the first delay is greater than the second delay.

10. The apparatus according to any of claim 7, wherein the retransmission of a third activation signal to the second passive radio device comprises performing the retransmission with the highest power and with the highest priority.

11. The apparatus according to claim 1, wherein the requests comprise information regarding key performance indicator of the passive radio devices which are assigned to the radio devices.

12. The apparatus according to claim 1, wherein the requests are comprised in one of the following: an information element in a physical sidelink shared channel, a small data transmission in downlink or uplink or a payload in a physical down- or uplink shared channel.

13. A method comprising:
receiving association information that comprises information regarding a plurality of passive radio devices and to which respective radio devices they are assigned, wherein the radio devices are configured to transmit an activation signal to the passive radio devices assigned to them;
determining categories for the passive radio devices comprised in the plurality of passive radio devices based, at least partly, on response signals received from at least some of the passive radio devices comprised in the plurality of the passive radio devices;
determining functionality regarding activating to be performed by the radio devices based on the category determined for passive radio devices assigned to them; and
transmitting to the radio devices requests, wherein the requests indicate the functionality regarding activating to be performed by the radio devices.

14. A computer program comprising instructions for causing an apparatus to perform at least the following:
receive association information that comprises information regarding a plurality of passive radio devices and to which respective radio devices they are assigned, wherein the radio devices are configured to transmit an activation signal to the passive radio devices assigned to them;
determine categories for the passive radio devices comprised in the plurality of passive radio devices based, at least partly, on response signals received from at least some of the passive radio devices comprised in the plurality of the passive radio devices;
determine functionality regarding activating to be performed by the radio devices based on the category determined for passive radio devices assigned to them; and
transmit to the radio devices requests, wherein the requests indicate the functionality regarding activating to be performed by the radio devices.

15.-22. (canceled)
